(19) United States
(12) Patent Application Publication
(10) Pub. No.: US 2021/0187634 A1
(43) Pub. Date: Jun. 24, 2021

(54) CUTTING INSERT, CUTTING TOOL, AND METHOD FOR MANUFACTURING MACHINED PRODUCT

(71) Applicant: KYOCERA Corporation, Kyoto-shi, Kyoto (JP)

(72) Inventor: Masahiro YAMAMOTO, Ritto-shi (JP)

(73) Assignee: KYOCERA Corporation, Kyoto-shi, Kyoto (JP)

(21) Appl. No.: 17/058,215

(22) PCT Filed: Jun. 3, 2019
(86) PCT No.: PCT/JP2019/021959

§ 371 Date: Nov. 24, 2020

(30) Foreign Application Priority Data
Jun. 1, 2018 (JP) 2018-106134

(51) Int. Cl. B23C 5/20; B23C 5/06

(52) U.S. Cl. CPC B23C 5/207; B23C 5/06; B23C 2200/203; B23C 2200/0433; B23C 2200/365

(57) ABSTRACT

A cutting insert may include a first surface. The first surface may include a first side, a second side, a first corner, a land surface and an inclined surface. The land surface may include a first land surface, a second land surface and a corner land surface. The first land surface may be located along the first side. The second land surface may be located along the second side. The corner land surface may be located along the first corner. The first land surface may include a part thereof where a first land angle increases as going away from the first corner. The corner land surface may include a part thereof where a corner land angle increases as going away from the first side.

### CROSS-REFERENCE TO RELATED APPLICATION

This application is a national stage entry according to 35 U.S.C. 371 of PCT Application No. PCT/JP2019/021959, filed on Jun. 3, 2019, which claims priority to Japanese Application No. 2018-106134, filed on Jun. 1, 2018, which are entirely incorporated herein by reference.

### TECHNICAL FIELD

The present disclose generally relates to cutting inserts for use in a cutting process. Specifically, the present disclose relates to cutting inserts for use in a milling process.

### BACKGROUND

For example, a cutting insert is discussed in WO 2004/050283 (Patent Document 1) as a cutting insert for use in a cutting process of a workpiece, such as metal. The cutting insert discussed in Patent Document 1 may include two end surfaces, a peripheral lateral surface and a cutting edge. The two end surfaces may have a rectangular shape and may be opposed to each other. The peripheral lateral surface may be extended between these end surfaces. The cutting edge may be formed on an intersecting part of the end surfaces and the peripheral lateral surface. A land surface may be located on a region in each of the end surfaces which is extended along the cutting edge.

### SUMMARY

A cutting insert in non-limiting aspects of the present disclosure may include a first surface, a second surface, a third surface and a cutting edge. The first surface may include a first side, a second side and a first corner. The first corner may be located between the first side and the second side. The second surface may be located on a side opposite to the first surface. The third surface may be located between the first surface and the second surface. The cutting edge may be located on at least a part of a ridgeline where the first surface intersects with the third surface.

An imaginary straight line passing through a center of the first surface and a center of the second surface may be a central axis. An imaginary flat surface which is located between the first surface and the second surface and which is orthogonal to the central axis may be a reference plane. The first surface may further include a land surface and an inclined surface. The land surface may be located along the first side, the second side and the first corner. The inclined surface may be located along the land surface and may become closer to the reference plane as going away from the land surface. The land surface may include a first land surface, a second land surface and a corner land surface. The first land surface may be located along the first side. The second land surface may be located along the second side. The corner land surface may be located along the first corner.

An inclination angle of the first land surface relative to the reference plane may be a first land angle. An inclination angle of the second land surface relative to the reference plane may be a second land angle. An inclination angle of the corner land surface relative to the reference plane may be a corner land angle. The first land surface may include a part thereof where the first land angle increases as going away from the first corner. The corner land surface may include a part thereof where the corner land angle increases as going away from the first side.

### BRIEF DESCRIPTION OF THE DRAWINGS

FIG. 1 is a perspective view illustrating a cutting insert in non-limiting aspects of the present disclosure;

FIG. 2 is a plan view of a first surface in the cutting insert illustrated in FIG. 1;

FIG. 3 is a side view of the cutting insert illustrated in FIG. 2 as viewed from a B1 direction;

FIG. 4 is a side view of the cutting insert illustrated in FIG. 2 as viewed from a B2 direction;

FIG. 5 is an enlarged view of a region A1 illustrated in FIG. 1;

FIG. 6 is an enlarged view of a region A2 illustrated in FIG. 2;

FIG. 7 is a plan view identical to that of the cutting insert illustrated in FIG. 2;

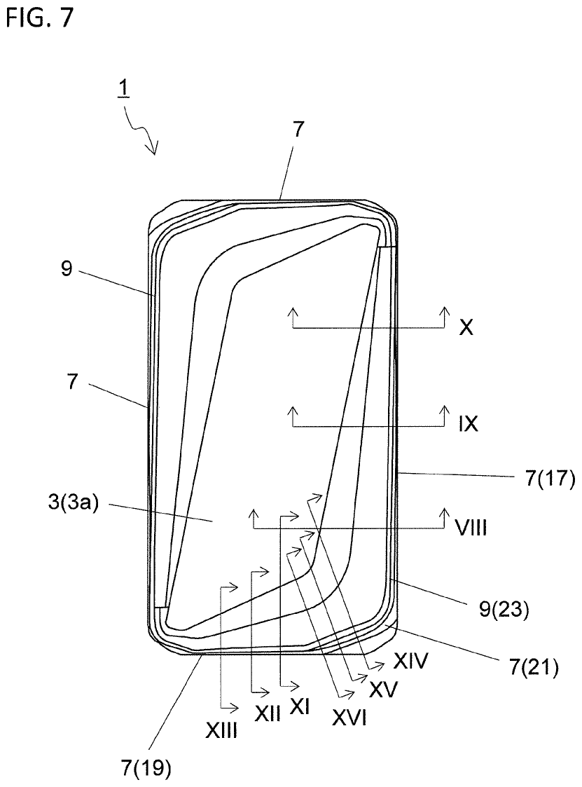

FIG. 8 is a cross-sectional view taken along the line VIII-VIII in the cutting insert illustrated in FIG. 7;

FIG. 9 is a cross-sectional view taken along the line IX-IX in the cutting insert illustrated in FIG. 7;

FIG. 10 is a cross-sectional view taken along the line X-X in the cutting insert illustrated in FIG. 7;

FIG. 11 is a cross-sectional view taken along the line XI-XI in the cutting insert illustrated in FIG. 7;

FIG. 12 is a cross-sectional view taken along the line XII-XII in the cutting insert illustrated in FIG. 7;

FIG. 13 is a cross-sectional view taken along the line XIII-XIII in the cutting insert illustrated in FIG. 7;

FIG. 14 is a cross-sectional view taken along the line XIV-XIV in the cutting insert illustrated in FIG. 7;

FIG. 15 is a cross-sectional view taken along the line XV-XV in the cutting insert illustrated in FIG. 7;

FIG. 16 is a cross-sectional view taken along the line XVI-XVI in the cutting insert illustrated in FIG. 7;

FIG. 17 is a perspective view illustrating a cutting tool in non-limiting aspects of the present disclosure;

FIG. 18 is an enlarged view of a region A3 illustrated in FIG. 17;

FIG. 19 is a schematic diagram illustrating one of steps in a method for manufacturing a machined product in non-limiting aspects of the present disclosure;

FIG. 20 is a schematic diagram illustrating one of the steps in the method for manufacturing a machined product in the non-limiting aspects of the present disclosure; and

FIG. 21 is a schematic diagram illustrating one of the steps in the method for manufacturing a machined product in the non-limiting aspects of the present disclosure.

### EMBODIMENTS

In general, a cutting edge may have high strength if an inclination angle of a land surface is small, and good cutting performance may be obtainable if the inclination angle of the land surface is large. During a cutting process of a workpiece for manufacturing a machined product, a principal force may be applied in a direction orthogonal to the land surface. Accordingly, if the inclination angle of the land surface is large, such a load as to push the cutting insert outward may tend to be applied. Consequently, machining accuracy may deteriorate due to dislocation of the cutting insert.

The cutting inserts 1 in non-limiting embodiments may be described in detail below with reference to the drawings. For the sake of description, the drawings referred to in the following may illustrate, in simplified form, only main members necessary for describing the non-limiting embodiments. The cutting inserts 1 disclosed in the following may therefore be capable of including any arbitrary structural member not illustrated in the drawings referred to. Dimensions of the members in each of the drawings faithfully may represent neither dimensions of actual structural members nor dimensional ratios of these members.

<Inserts>

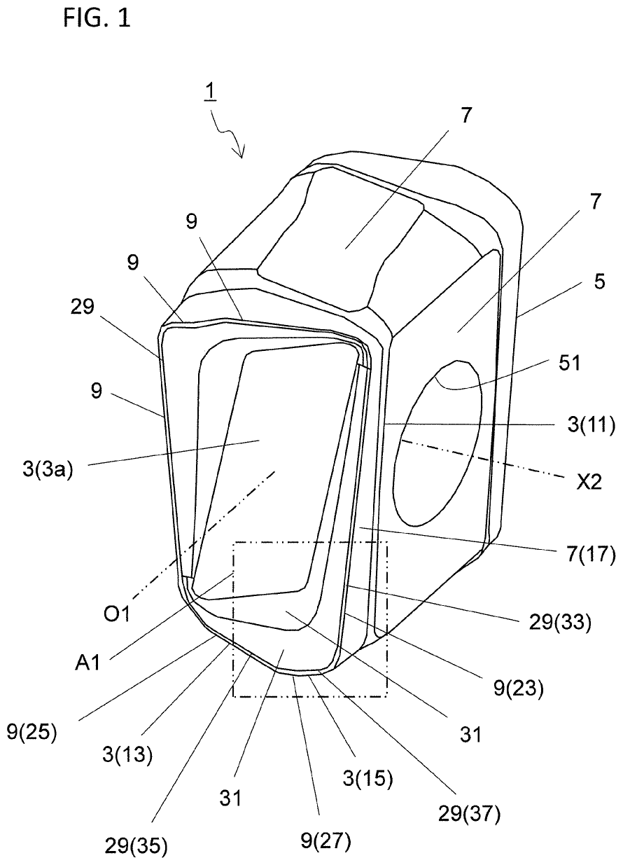

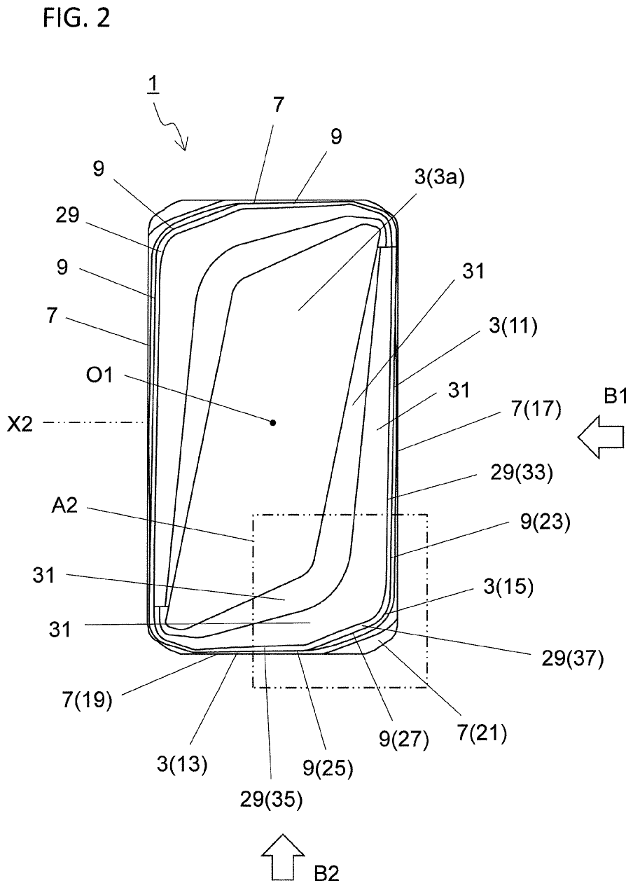

The cutting insert 1 (hereinafter also referred to simply as “the insert 1”) in non-limiting aspects of the present disclosure may include, for example, a first surface 3, a second surface 5, a third surface 7 and a cutting edge 9. The first surface 3 may have a polygonal shape including corners and sides as illustrated in FIG. 2. The first surface 3 may have an approximately rectangular shape as in a non-limiting embodiment illustrated in FIG. 2. The second surface 5 may be located on a side opposite to the first surface 3. Similarly to the first surface 3, the second surface 5 may have a polygonal shape including corners and sides. Similarly to the first surface 3, the second surface 5 may have an approximately rectangular shape. The insert 1 may have a quadrangular plate shape as illustrated in FIG. 1.

The term “polygonal shape” may not denote a strict polygonal shape. For example, the four corners of the first surface 3 may be slightly curved in a plan view of the first surface 3, instead of being a strict straight line. The four corners of the first surface 3 may not be individually a strict corner.

The first surface 3 may have a rectangular shape and may include four corners and four sides as illustrated in FIG. 2. One of the sides in the first surface 3 may be a first side 11. One of long sides of the first surface 3 may be the first side 11 as illustrated in FIG. 2. One of short sides of the first surface 3 may be a second side 13 as illustrated in FIG. 2.

A corner located between the first side 11 and the second side 13 on the first surface 3 may be a first corner 15. In other words, the first side 11 and the second side 13 may be individually extended from the first corner 15. Because the first surface 3 is the rectangular shape in the non-limiting embodiment illustrated in FIG. 2, an angle formed by an extension line of the first side 11 and an extension line of the second side 13 may be approximately 90° in a plan view of the first surface 3.

An imaginary straight line passing through a center of the first surface 3 and a center of the second surface 5 may be a central axis O1. An imaginary flat surface that is located between the first surface 3 and the second surface 5 and is orthogonal to the central axis O1 may be a reference plane S1. An intersection of diagonals on the first surface 3 may be the center of the first surface 3 as illustrated in FIG. 1. An intersecting part of extension lines of the individual sides constituting the rectangular shape may serve as a starting point of the diagonals.

Similarly, an intersection of diagonals on the second surface 5 may be the center of the second surface 5. If the first surface 3 does not have a rectangular shape, the center of the first surface 3 may be determined by, for example, a position of a center of gravity of the first surface 3 in the plan view of the first surface 3.

The four corners and the four sides of the first surface 3 may have 180° rotational symmetry around the central axis O1 in the plan view of the first surface 3. The second surface 5 may have 180° rotational symmetry around the central axis O1 in the plan view.

Shapes of the first surface 3 and the second surface 5 are not limited to the above shape. The shape of the first surface 3 may be an approximately quadrangular shape. The first surface 3 and the second surface 5 may have, for example, a triangular shape, pentagonal shape, hexagonal shape or octagonal shape.

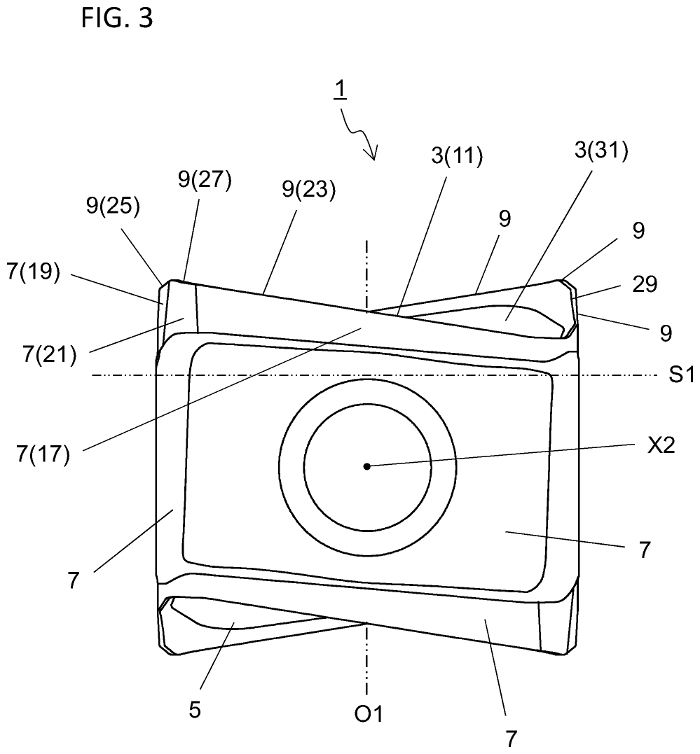

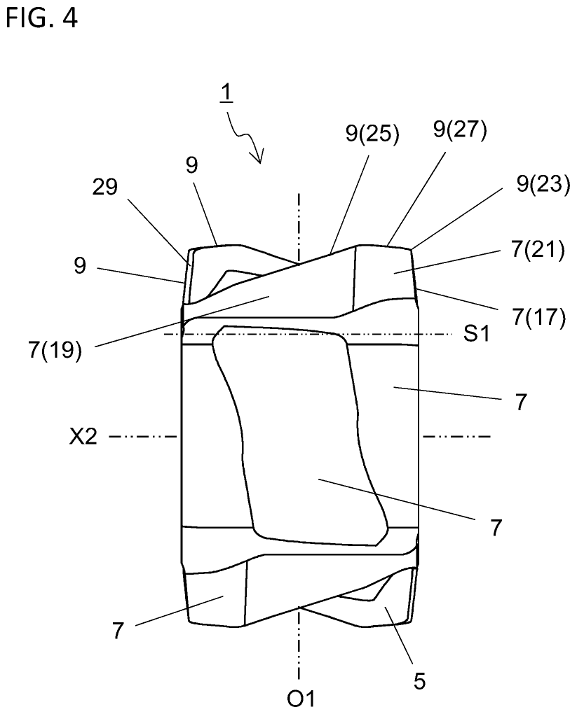

The third surface 7 may be located between the first surface 3 and the second surface 5 in non-limiting aspects of the present disclosure. Hereinafter, the third surface may be referred to as a lateral surface 7. The lateral surface 7 may connect to the first surface 3 and the second surface 5 as illustrated in FIGS. 3 and 4. The lateral surface 7 may include a first lateral surface 17, a second lateral surface 19 and a first corner lateral surface 21 as illustrated in FIGS. 3 and 4. The first lateral surface 17 may be located along the first side 11. The second lateral surface 19 may be located along the second side 13. The first corner lateral surface 21 may be located along the first corner 15.

A maximum width of the first surface 3 in the plan view thereof may be, for example, 6-25 mm. A height from the first surface 3 to the second surface 5 may be, for example, 5-20 mm. The term “the height from the first surface 3 to the second surface 5” may denote a maximum value of a space between the first surface 3 and the second surface 5 in a direction parallel to the central axis O1, in other words, a width of the lateral surface 7 in a direction along the central axis O1.

The insert 1 may include a cutting edge 9 located on at least a part of a ridgeline where the first surface 3 intersects with the lateral surface 7 in non-limiting aspects of the present disclosure. The cutting edge 9 may be usable for cutting a workpiece during the time that a machined product is manufactured using the insert 1. The cutting edge 9 may be located on the whole or a part of the ridgeline. Alternatively, the insert 1 may further include other cutting edge located on at least a part of a ridgeline where the second surface 5 intersects with the lateral surface 7.

If the cutting edge 9 is located on at least the part of the ridgeline, one of the first surface 3 and the lateral surface 7 may include a rake surface region. If the cutting edge is located on at least the part of the ridgeline, the other of the first surface 3 and the lateral surface 7 may include a flank surface region. The first surface 3 may include the rake surface region and the lateral surface 7 may include the flank surface region as illustrated in FIG. 1.

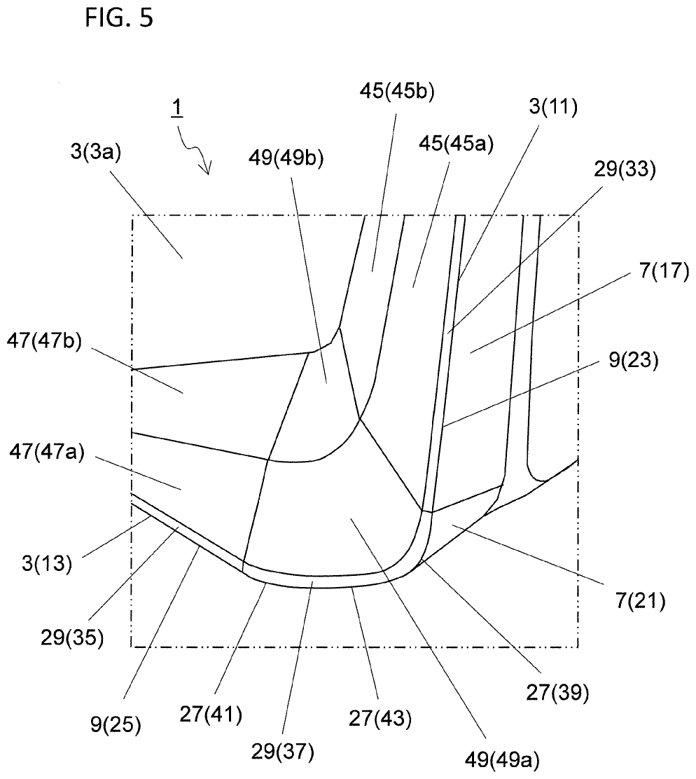

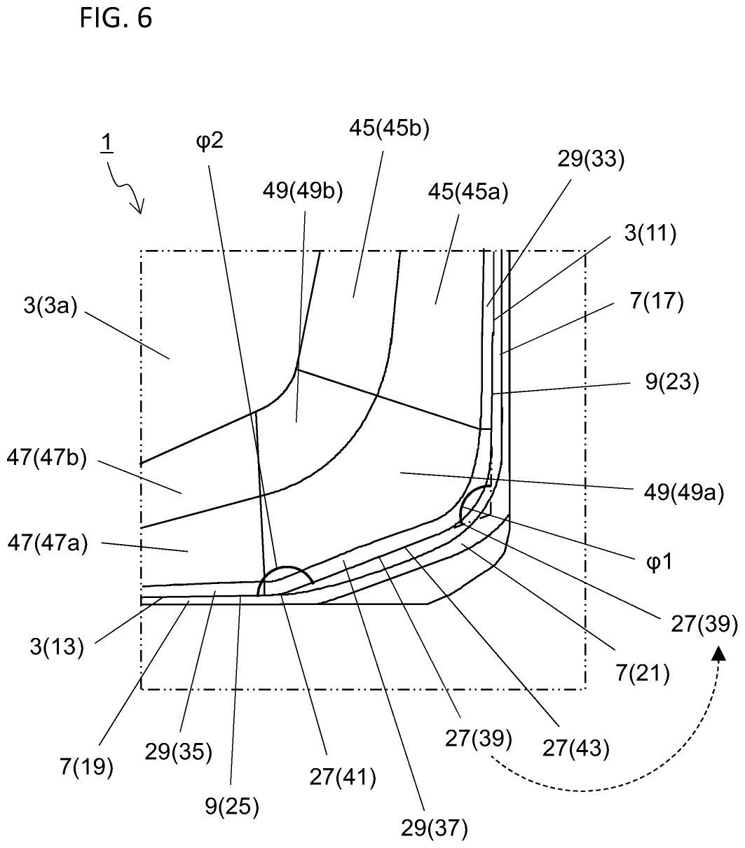

The cutting edge 9 may include a first cutting edge 23, a second cutting edge 25 and a corner cutting edge 27 as illustrated in FIGS. 5 and 6. The first cutting edge 23 may be located at the first side 11. The second cutting edge 25 may be located at the second side 13. The corner cutting edge 27 may be located at the first corner 15. The corner cutting edge 27 may be located on the whole or a part of the first corner 15. The corner cutting edge 27 may be located on the whole of the first corner 15 as illustrated in FIGS. 5 and 6.

The first cutting edge 23 may be located on the whole or a part of the first side 11. As illustrated in FIG. 1, the first cutting edge 23 may be extended from an end portion of the first side 11 which is located at a side of the first corner 15, toward an end portion thereof located at a side away from the first corner 15. The second cutting edge 25 may be located on the whole or a part of the second side 13. As illustrated in FIG. 1, the second cutting edge 25 may be extended from an end portion of the second side 13 which is located at a side of the first corner 15, toward an end portion thereof located at a side away from the first corner 15.

For example, the second cutting edge 25 may be usable as a bottom cutting edge located along a machined surface (finished surface) of a workpiece during a cutting process of the workpiece by using the insert 1 in non-limiting aspects of the present disclosure. Alternatively, the first cutting edge 23 may be used as an outer peripheral cutting edge. In cases where the second cutting edge 25 is used as the bottom cutting edge and the first cutting edge 23 is used as the outer peripheral cutting edge as described above, the first cutting edge 23 may mainly contribute to the cutting process. The first cutting edge 23 may therefore be referred to as a main cutting edge in some cases.

The first surface 3 may include a land surface 29 and an inclined surface 31 as illustrated in FIGS. 5 and 6. The land surface 29 may be located along the first side 11, the second side 13 and the first corner 15. In other words, the land surface 29 may be located along the first cutting edge 23, the second cutting edge 25 and the corner cutting edge 27. If the first surface 3 includes the land surface 29, the cutting edge 9 may have enhanced durability.

The inclined surface 31 may be located along the land surface 29. The inclined surface 31 may be located more inside the first surface 3 than the land surface 29. The inclined surface 31 may become closer to the reference plane S1 as going away from the land surface 29. The inclined surface 31 of the first surface 3 may be the rake surface region described above.

If the first surface 3 includes the inclined surface 31 servable as the rake surface, it may be easy to control a flow direction of chips generated by the cutting edge 9 during the cutting process. This may lead to enhanced chip discharge performance. An inclination angle of the inclined surface 31 may be larger than an inclination angle of the land surface 29. The term “inclination angle” of the land surface 29 and the inclined surface 31 may denote an inclination angle relative to the reference plane S1.

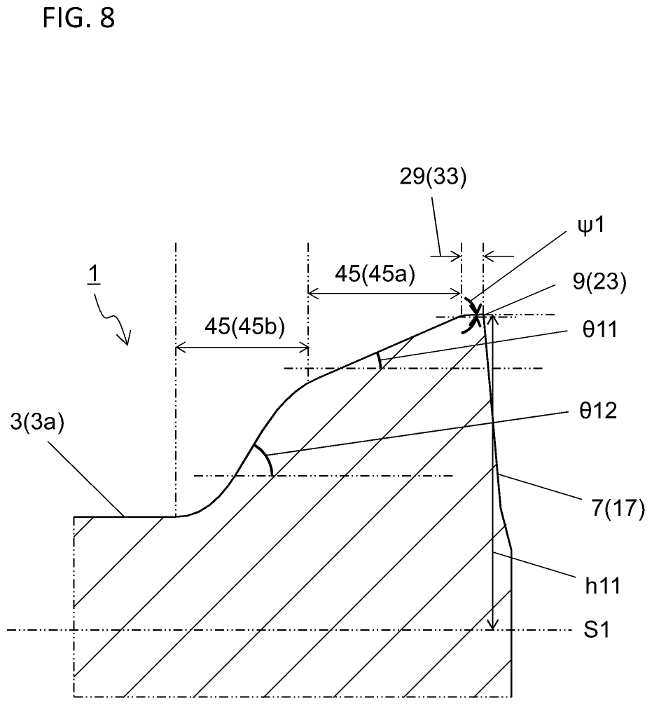

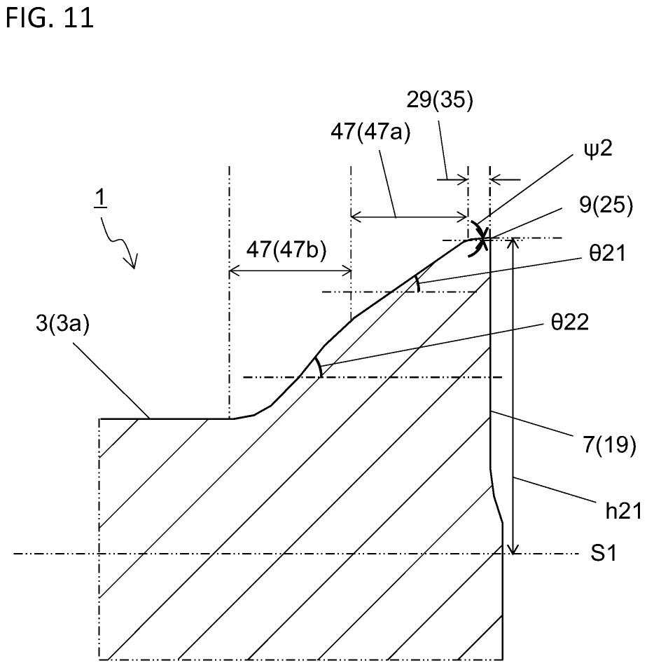

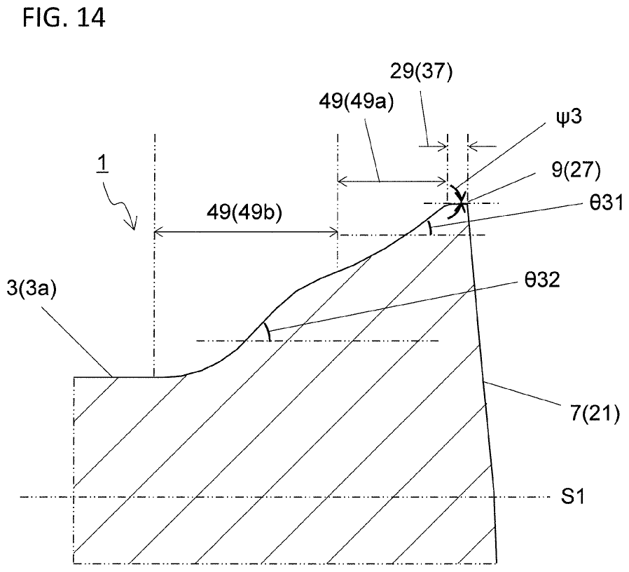

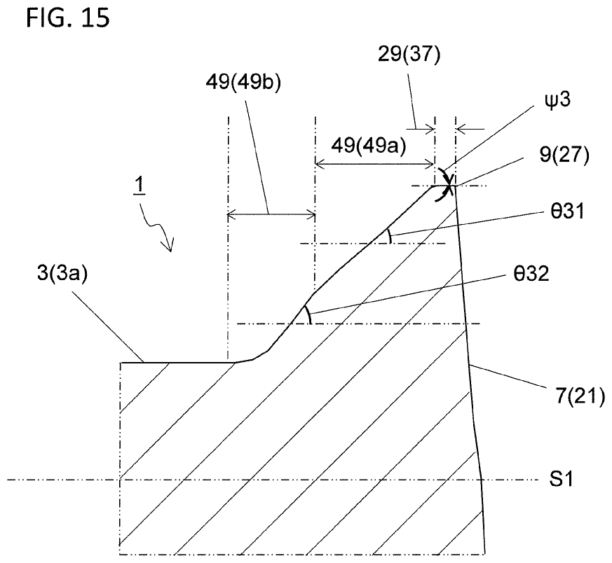

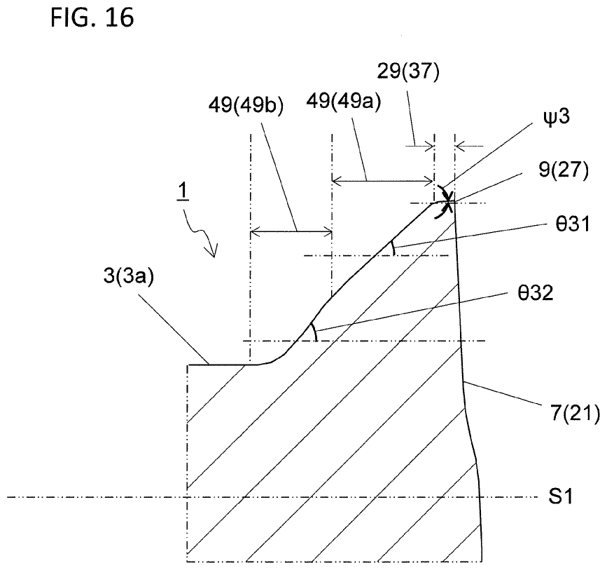

The land surface 29 may include a first land surface 33, a second land surface 35 and a corner land surface 37 as in a non-limiting embodiment illustrated in FIGS. 5 and 6. The first land surface 33 may be located along the first side 11. The second land surface 35 may be located along the second side 13. The corner land surface 37 may be located along the first corner 15. As illustrated in FIGS. 8 to 10, an inclination angle of the first land surface 33 relative to the reference plane S1 may be a first land angle ψ1. As illustrated in FIGS. 11 to 13, an inclination angle of the second land surface 35 relative to the reference plane S1 may be a second land angle ψ2. As illustrated in FIGS. 14 to 16, an inclination angle of the corner land surface 37 relative to the reference plane S1 may be a corner land angle ψ3.

The first land angle ψ1 and the corner land angle ψ3 may be kept constant or changed. For example, the first land surface may include a part thereof where the first land angle ψ1 increases as going away from the first corner 15. The corner land surface 37 may include a part thereof where the corner land angle ψ3 increases as going away from the first side 11.

A large cutting load may tend to be applied in the vicinity of a boundary between the first cutting edge 23 and the corner cutting edge 27 during the cutting process of the workpiece. If the land surface 33 includes the part thereof where the first land angle ψ1 increases as going away from the first corner 15, the first land angle ψ1 may tend to become relatively small at a part of the first land surface 33 which is located in the vicinity of the first corner 15.

Accordingly, even if the large cutting load is applied in the vicinity of the boundary between the first cutting edge 23 and the corner cutting edge 27, it may be less susceptible to a force in a direction to push the insert 1 outward (a rightward direction in FIG. 2). It may therefore be possible to reduce the dislocation of the insert 1 relative to a holder. This may lead to the highly accurate cutting process.

If the first land surface 33 includes the part thereof where the first land angle ψ41 increases as going away from the first corner 15, the first land angle ψ41 may tend to become relatively large at a part of the first land surface 33 which is located away from the first corner 15. It may therefore be possible to reduce a cutting load in at least the part of the first land surface 33 which is located away from the first corner 15. Accordingly, the cutting load applied to the whole of the insert 1 can be minimized, and consequently the insert 1 satisfying the above configuration may have enhanced durability.

The corner land surface 37 may include the part thereof where the corner land angle ψ3 increases as going away from the first side 11, the corner land angle ψ43 may tend to become relatively small at a part of the corner land surface 37 which is located in the vicinity of the first side 11.

Accordingly, even if the large cutting load is applied in the vicinity of the boundary between the first cutting edge 23 and the corner cutting edge 27, it may be less susceptible to the force in the direction to push the insert 1 outward (a lower right direction in FIG. 2). It may therefore be possible to reduce the dislocation of the insert 1 relative to the holder. This may lead to the highly accurate cutting process.

If the corner land surface 37 includes a part thereof where the corner land angle ψ3 increases as going away from the first side 11, the corner land angle ψ3 at a part of the corner land surface 37 which is located away from the first side 11 may tend to become relatively large. It may therefore be possible to reduce the cutting load in at least the part of the corner land surface 37 which is located away from the first side 11. Accordingly, the cutting load applied to the whole of the insert 1 can be minimized, and consequently the insert 1 satisfying the above configuration may have enhanced durability.

The first land angle ψ1, the second land angle ψ2 and the third land angle ψ3 are not individually limited to a specific value. A value of the first land angle ψ1 may be settable to, for example, 0-10°. A value of the second land angle ψ2 may be settable to, for example, 0-5°. A value of the third land angle ψ3 may be settable to, for example, 0-15°.

As illustrated in FIGS. 8 to 10, the first land surface 33 may include a part thereof where the first land angle ψ1 increases as going away from the first corner 15. A difference 41 between a maximum value and a minimum value of the first land angle ψ41 may be, for example, 5° or more. If the 41 is 5° or more, it may be easy to suitably obtain both a reduction in dislocation of the insert 1 and the enhanced durability of the insert 1. A difference 43 between a maximum value and a minimum value of the corner land angle ψ43 may be, for example, 5° or more. If the 43 is 5° or more, the dislocation of the insert 1 can be reduced, and the insert 1 may have the enhanced durability.

A maximum value of the second land angle ψ2 may be larger than a maximum value of the first land angle ψ41. For example, if the maximum value of the second land angle ψ2 is larger than the maximum value of the first land angle ψ1 when using the second cutting edge 25 as a bottom cutting edge, a machined surface of a workpiece may have enhanced surface accuracy.

During use of the second cutting edge 25 as the bottom cutting edge, chips generated by the second cutting edge 25 may be thin, and a smaller load may be applied to the second cutting edge 25 than to the first cutting edge 23 and the first corner cutting edge 27. The insert 1 may therefore be less susceptible to dislocation even if the maximum value of the second land angle ψ2 is relatively large.

The second land angle ψ42 may be kept constant or changed. For example, the second land surface 35 may include a part thereof where the second land angle ψ2 increases as going away from the first corner 15 as illustrated in FIGS. 11 to 13.

A large cutting load may tend to be applied in the vicinity of the boundary between the first cutting edge 23 and the corner cutting edge 27 during the cutting process of the workpiece. If the second land surface 35 includes the part thereof where the second land angle ψ2 increases as going away from the first corner 15, the second land angle ψ42 at a part of the second land surface 35 which is located in the vicinity of the first corner 15 may tend to become relatively small.

Hence, even if the large cutting load is applied in the vicinity of the boundary between the first cutting edge 23 and the corner cutting edge 27, it may be less susceptible to the force in the direction to push the insert 1 outward (a downward direction in FIG. 2). It may therefore be possible to reduce the dislocation of the insert 1 relative to the holder. This may lead to the highly accurate cutting process.

If the second land surface 35 includes a part thereof where the second land angle ψ2 increases as going away from the first corner 15, the second land angle ψ42 at a part of the second land surface 35 which is located away from the first corner 15 may tend to become relatively large. It may therefore be possible to reduce a cutting load in at least the part of the second land surface 35 which is located away from the first corner 15. Accordingly, the cutting load applied to the whole of the insert 1 can be minimized, and consequently the insert 1 satisfying the above configuration may have enhanced durability.

As stated earlier, in the non-limiting embodiment illustrated in FIG. 2, one of the long sides of the first surface 3 may be the first side 11, and one of the short sides of the first surface 3 may be the second side 13. Specifically, the first surface 3 may have a rectangular shape, the first side 11 may be the long side and the second side 13 may be the short side in a plan view of the first surface 3.

If the first surface 3 has the above configuration, the following configuration may be particularly effective. That is, the first land surface 33 may include the part thereof where the first land angle ψ41 increases as going away from the first corner 15 in the insert 1 of a non-limiting embodiment illustrated in FIGS. 8 to 10.

If the first side 11 is the long side, the first cutting edge 23 may tend to become longer than each of the second cutting edge 25 and the corner cutting edge 27, and a length in a direction along the first side 11 on the first land surface 33 located along the first cutting edge 23 also may tend to become longer. In cases where the above length on the first land surface 33 is large, it may be difficult to accomplish both the highly accurate cutting process and the enhanced durability of the insert 1 if the first land angle ψ1 is kept constant. However, if the first land surface 33 includes the part thereof where the first land angle ψ41 increases as going away from the first corner 15, the insert 1 satisfying this configuration may be capable of offering the highly accurate cutting process and the enhanced durability.

Widths of the first land surface 33, the second land surface 35 and the corner land surface 37 in the plan view of the first surface 3 are not individually limited to a specific value. The widths of the first land surface 33, the second land surface 35 and the corner land surface 37 may be kept constant or changed.

For example, the second land surface 35 may include a part thereof whose width decreases as going away from the corner land surface 37 in the plan view of the first surface 3. If the second land surface 35 has the above configuration, the insert 1 satisfying this configuration may achieve high surface accuracy of a finished surface.

The width of the second land surface 35 may denote a length of the second land surface 35 in a direction orthogonal to a part of the second side 13 which is extended along a measurement target region on the second land surface 35. The width of the first land surface 33 and the width of the corner land surface 37 may be evaluated in a similar manner.

The width of the second land surface 35 may be measured at five points located at equal intervals in a direction along the second side 13 on the second land surface 35. If measured widths decrease as going away from the corner land surface 37, it may be regarded that the width of the second land surface 35 decreases as going away from the corner land surface 37.

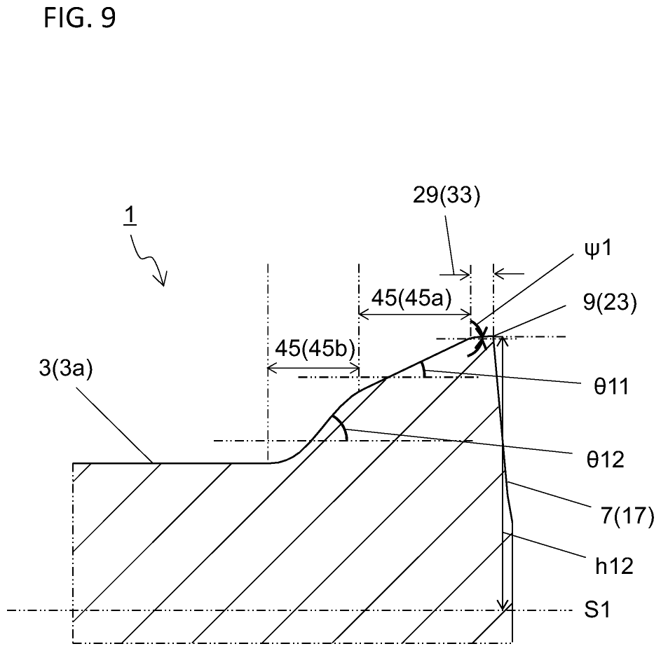

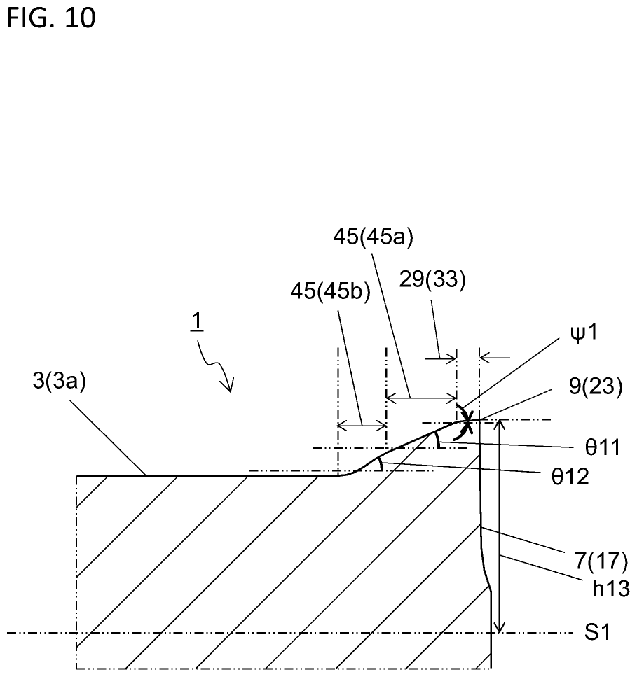

As in a non-limiting embodiment illustrated in FIG. 3, the first cutting edge 23 located on at least a part of the first side 11 may include a part thereof that becomes closer to the reference plane S1 as going away from the first corner 15. For example, a height of the first cutting edge 23 from the reference plane S1 may be denoted by h11 as illustrated in FIG. 8. A height of the first cutting edge 23 from the reference plane S1 may be denoted by h12 as illustrated in FIG. 9. A height of the first cutting edge 23 from the reference plane S1 may be denoted by h13 as illustrated in FIG. 10. These heights may have a relationship of h11>h12>h13 as illustrated in FIGS. 8 to 10.

If the first cutting edge 23 has the above configuration, the first cutting edge 23 may be subjected to a small cutting load. Accordingly, it may be less susceptible to the force in the direction to push the insert 1 outward (the rightward direction in FIG. 2) which is due to a cutting load applied to the first cutting edge 23. It may therefore be possible to reduce the dislocation of the insert 1 relative to the holder.

The phrase that “the first cutting edge 23 becomes closer to the reference plane S1 as going away from the first corner 15” may denote that at least the first cutting edge 23 is not located further away from the reference plane S1 as going away from the first corner 15. Hence, the first cutting edge 23 may partially include a part thereof whose height from the reference plane S1 is kept constant.

In cases where, instead of the configuration that the first cutting edge 23 partially includes the part thereof whose height from the reference plane S1 is kept constant, the configuration that the whole of the first cutting edge 23 becomes closer to the reference plane S1 as going away from the first corner 15, it may be much less susceptible to the force in the direction to push the insert 1 outward (the rightward direction in FIG. 2). It may therefore be possible to further reduce the dislocation of the insert 1 relative to the holder.

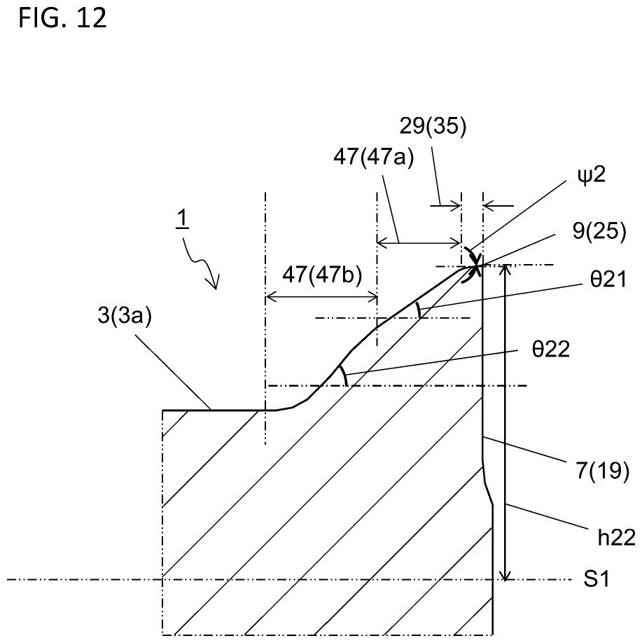

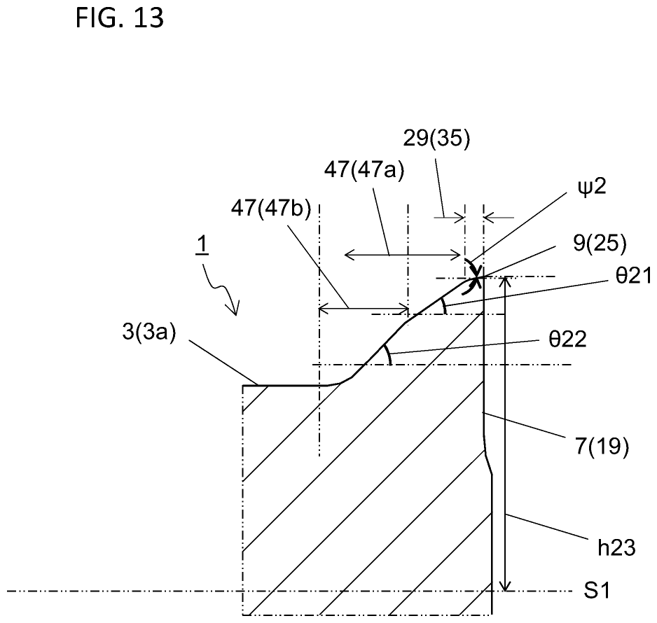

The second cutting edge 25 located on at least a part of the second side 13 may include a part thereof that becomes closer to the reference plane S1 as going away from the first corner 15 as in a non-limiting embodiment illustrated in FIG. 4. A height of the second cutting edge 25 from the reference plane S1 may be denoted by h21 as illustrated in FIG. 11. A height of the second cutting edge 25 from the reference plane S1 may be denoted by h22 as illustrated in FIG. 12. A height of the second cutting edge 25 from the reference plane S1 may be denoted by h23 as illustrated in FIG. 13. These heights may have a relationship of h21>h22>h23 as illustrated in FIGS. 11 to 13.

If the second cutting edge 25 has the above configuration, the second cutting edge 25 may be subjected to a small cutting load. Accordingly, it may be less susceptible to the force in the direction to push the insert 1 outward (the downward direction in FIG. 2) which is due to a cutting load applied to the second cutting edge 25. It may therefore be possible to reduce the dislocation of the insert 1 relative to the holder.

The phrase that “the second cutting edge 25 becomes closer to the reference plane S1 as going away from the first corner 15” may denote that at least the second cutting edge 25 is not located further away from the reference plane S1 as going away from the first corner 15. Hence, the second cutting edge 25 may partially include a part thereof whose height from the reference plane S1 is kept constant.

With the configuration that the whole of the second cutting edge 25 becomes closer to the reference plane S1 as going away from the first corner 15, it may be much less susceptible to the force in the direction to push the insert 1 outward (the downward direction in FIG. 2). It may therefore be possible to further reduce the dislocation of the insert 1 relative to the holder.

The first corner 15 may not be a strict corner formed by an intersection of the first side 11 with the second side 13. For example, the first corner 15 may have a convex curvilinear shape that is protruded outward in the plan view of the first surface 3. Alternatively, the first corner 15 may be formed by combining a straight line and a curved line as in a non-limiting embodiment illustrated in FIG. 6.

The first corner 15 may be formed by a curvilinear part. The first corner 15 may be formed by a first curvilinear part 39, a second curvilinear part 41 and a connection part 43 in the plan view of the first surface 3 as illustrated in FIG. 6. The first curvilinear part 39 may be located at a part of the first corner 15 which is located closer to the first side 11 and may have a convex curvilinear shape protruded outward. The second curvilinear part 41 may be located at a part of the first corner 15 which is located closer to the second side 13 and may have a convex curvilinear shape protruded outward. The connection part 43 may connect to the first curvilinear part 39 and the second curvilinear part 41, and may have a straight line shape.

If the first corner 15 includes the connection part 43, a cutting load applied to the corner cutting edge 27 can be reduced, thus leading to enhanced durability of the corner cutting edge 27. If the first corner 15 includes the first curvilinear part 39, a cutting load may be less likely to be accumulated in the vicinity of a boundary between the first corner 15 and the first side 11. If the first corner 15 includes the second curvilinear part 41, a cutting load may be less likely to be accumulated in the vicinity of a boundary between the first corner 15 and the second side 13.

A shape of the first curvilinear part 39 and a shape of the second curvilinear part 41 in the plan view of the first surface 3 are not particularly limited as long as both have the convex curvilinear shape. The first curvilinear part 39 and the second curvilinear part 41 may have a circular arc shape as illustrated in FIG. 6.

In cases where the first corner 15 includes the first curvilinear part 39 and the second curvilinear part 41 each having the circular arc shape, a radius of curvature of the first curvilinear part 39 and that of the second curvilinear part 41 are not limited to a specific value. For example, the radius of curvature of the first curvilinear part 39 may be larger than that of the second curvilinear part 41.

For example, if the first cutting edge 23 is used as an outer peripheral cutting edge and the second cutting edge 25 is used as a bottom cutting edge, a large cutting load may tend to applied in the vicinity of a boundary between the first corner and the first side 11 than in the vicinity of a boundary between the first corner 15 and the second side 13.

If the radius of curvature of the first curvilinear part 39 is larger than that of the second curvilinear part 41, the first curvilinear part 39 may have higher durability than the second curvilinear part 41. Therefore, even if a relatively large cutting load is applied in the vicinity of the boundary between the first corner 15 and the first side 11, the insert 1 may have enhanced durability. The insert 1 may be highly versatile because the first cutting edge 23 is usable as the excellent outer peripheral cutting edge, and the second cutting edge 25 is usable as the excellent bottom cutting edge.

If the radius of curvature of the second curvilinear part is smaller than that of the first curvilinear part 39, the second cutting edge 25 may be subjected to a small cutting load during a cutting process. This may lead to improved surface accuracy of a machined surface.

An angle formed by an imaginary line extended from the first side 11 and an imaginary line extended from the connection part 43 in the plan view of the first surface 3 may be a first imaginary angle ϕ1. An angle formed by an imaginary line extended from the second side 13 and an imaginary line extended from the connection part 43 may be a second imaginary angle ϕ2.

For example, the first imaginary angle ϕ1 may be smaller than the second imaginary angle ϕ2 as in a non-limiting embodiment illustrated in FIG. 6. In this case, the first corner 15 may be subjected to a small cutting load. Accordingly, it may be less susceptible to a force in a direction to push the insert 1 outward (a lower right direction in FIG. 2). It may therefore be possible to further reduce the dislocation of the insert 1 relative to the holder.

The connection part 43 may be located further away from the reference plane S1 as going from a side of the first curvilinear part 39 toward a side of the second curvilinear part 41 as in the non-limiting embodiment illustrated in FIG. 4. The connection part 43 may be inclined so as to extend upward as going from the side of the first curvilinear part 39 toward the side of the second curvilinear part 41 as in the non-limiting embodiment illustrated in FIG. 4.

With the connection part 43 having the above configuration, the connection part 43 may be susceptible to a cutting load in a leftward direction in FIG. 2. This may be offset by the force to push the insert 1 outward (the rightward direction in FIG. 2), thereby further reducing the dislocation of the insert 1 relative to the holder.

The first curvilinear part 39 may have a curvilinear shape recessed in a direction becoming closer to the reference plane S1 in a side view. The first curvilinear part 39 having the above configuration may facilitate a smooth connection of the connection part 43 and the first side 11. A large cutting load may therefore be less likely to be applied in the vicinity of a boundary between the first cutting edge 23 and the corner cutting edge 27.

The second curvilinear part 41 may have a curvilinear shape protruded in a direction away from the reference plane S1 in the side view. If the connection part 43 is inclined as described, the second curvilinear part 41 located between the connection part 43 and the second side 13 may be protruded upward. In this case, the second curvilinear part 41 may tend to become a portion for biting a workpiece during the cutting process, and a large cutting load may tend to be applied to the second curvilinear part 41. With the second curvilinear part 41 having the above configuration, the insert 1 may have enhanced durability because of high strength of the second curvilinear part 41.

The inclined surface 31 may include a first inclined surface 45, a second inclined surface 47 and a corner inclined surface 49 as in a non-limiting embodiment illustrated in FIGS. 5 and 6. The first inclined surface 45 may be located along the first side 11. The second inclined surface 47 may be located along the second side 13. The corner inclined surface 49 may be located along the first corner 15. If the inclined surface 31 includes the first inclined surface 45, the second inclined surface 47 and the corner inclined surface 49, it may be easy to control a flow direction of chips generated by the first cutting edge 23, the second cutting edge 25 and the corner cutting edge 27.

The first inclined surface 45, the second inclined surface 47 and the corner inclined surface 49 may be individually formed by one or a plurality of surface regions. For example, the first inclined surface 45, the second inclined surface 47 and the corner inclined surface 49 may be individually formed by two surface regions as illustrated in FIGS. 5 and 6.

The first inclined surface 45 may include a first outer inclined surface 45a and a first inner inclined surface 45b as illustrated in FIGS. 5 and 6. The first outer inclined surface 45a may be located along the first land surface 33. The first inner inclined surface 45b may be located along the first outer inclined surface 45a. An inclination angle of the first inner inclined surface 45b may be larger than that of the first outer inclined surface 45a as illustrated in FIGS. 8 to 10.

If an inclination angle θ11 of the first outer inclined surface 45a is relatively small, the first cutting edge 23 may have high strength. If an inclination angle θ12 of the first inner inclined surface 45b is relatively large, the first inclined surface 45 may be less subjected to contact with chips. A ridgeline may be located on a boundary part between the first outer inclined surface 45a and the first inner inclined surface 45b as in a non-limiting embodiment illustrated in FIGS. 5 and 6.

The second inclined surface 47 may include a second outer inclined surface 47a and a second inner inclined surface 47b as in the non-limiting embodiment illustrated in FIGS. 5 and 6. The second outer inclined surface 47a may be located along the second land surface 35. The second inner inclined surface 47b may be located along the second outer inclined surface 47a. An inclination angle of the second inner inclined surface 47b may be larger than that of the second outer inclined surface 47a as illustrated in FIGS. 11 to 13.

If an inclination angle θ21 of the second outer inclined surface 47a is relatively small, the second cutting edge 25 may have high strength. If an inclination angle θ22 of the second inner inclined surface 47b is relatively large, the second inclined surface 47 may be less subjected to contact with chips. A ridgeline may be located on a boundary part between the second outer inclined surface 47a and the second inner inclined surface 47b as in a non-limiting embodiment illustrated in FIGS. 5 and 6.

The corner inclined surface 49 may include a corner outer inclined surface 49a and a corner inner inclined surface 49b as in the non-limiting embodiment illustrated in FIGS. 5 and 6. The corner outer inclined surface 49a may be located along the corner land surface 37. The corner inner inclined surface 49b may be located along the corner outer inclined surface 49a. An inclination angle of the corner inner inclined surface 49b may be larger than that of the corner outer inclined surface 49a as illustrated in FIGS. 14 to 16.

If an inclination angle θ31 of the corner outer inclined surface 49a is relatively small, the corner cutting edge 27 may have high strength. If an inclination angle θ32 of the corner inner inclined surface 49b is relatively large, the corner inclined surface 49 may be less subjected to contact with chips. A ridgeline may be located on a boundary part between the corner outer inclined surface 49a and the corner inner inclined surface 49b as in the non-limiting embodiment illustrated in FIGS. 5 and 6.

The first outer inclined surface 45a, the first inner inclined surface 45b, the second outer inclined surface 47a, the second inner inclined surface 47b, the corner outer inclined surface 49a and the corner inner inclined surface 49b may be individually a flat surface or curved surface. If the inclined surface 31 is the curved surface and indicated by a curved line in a specific cross section, a maximum value of an angle relative to the reference plane S1 may be an inclination angle. For example, the maximum value of the angle relative to the reference plane S1 on the corner outer inclined surface 49a having the concave curvilinear shape may be denoted by an inclination angle θ31 in cross sections illustrated in FIGS. 14 to 16.

The inclination angle θ11 of the first outer inclined surface 45a, the inclination angle θ12 of the first inner inclined surface 45b, the inclination angle θ21 of the second outer inclined surface 47a, the inclination angle θ22 of the second inner inclined surface 47b, the inclination angle θ31 of the corner outer inclined surface 49a and the inclination angle θ32 of the corner inner inclined surface 49b are not individually limited to a specific value.

A value of the inclination angle θ11 may be settable to, for example, 5-35°. A value of the inclination angle θ12 may be settable to, for example, 15-65°. A value of the inclination angle θ21 may be settable to, for example, 10-40°. A value of the inclination angle θ22 may be settable to, for example, 15-65°. A value of the inclination angle θ31 may be settable to, for example, 15-45°. A value of the inclination angle θ32 may be settable to, for example, 15-65°.

As illustrated in FIGS. 8 and 9, the first outer inclined surface 45a may include a part thereof where the inclination angle θ11 decreases as going away from the first corner 15. In cases where the first land surface 33 includes a part thereof where the first land angle ψ41 increases as going away from the first corner 15 and the inclination angle θ11 of the first outer inclined surface 45a is in the above state, the durability of the first cutting edge 23 may be less likely to deteriorate. The above configuration may therefore be effective if the durability is needed for the first cutting edge 23.

As illustrated in FIGS. 9 and 10, the first outer inclined surface 45a may include a part thereof where the inclination angle ψ11 increases as going away from the first corner 15. In cases where the first land surface 33 includes a part thereof where the first land angle ψ41 increases as going away from the first corner 15 and the inclination angle ψ11 of the first outer inclined surface 45a is in the above state, the first cutting edge 23 offers high cutting performance. The above configuration may therefore be effective if the cutting performance is needed for the first cutting edge 23.

As in a non-limiting embodiment illustrated in FIGS. 8 to 10, the first outer inclined surface 45a may include a part thereof where the inclination angle θ11 decreases as going away from the first corner 15, and a part thereof where the inclination angle θ11 increases as going away from the first corner 15. In the non-limiting embodiment illustrated in FIGS. 8 to 10, the first inclined surface 45 may have these two parts, and the first outer inclined surface 45a may have a convex shape in a direction along the first cutting edge 23. This may lead to a stable flow direction of chips generated by the first cutting edge 23.

The first inner inclined surface 45b may include a part thereof where the inclination angle θ12 decreases as going away from the first corner 15 as in the non-limiting embodiment illustrated in FIGS. 8 to 10. In other words, the first inner inclined surface 45b may include a part thereof where the inclination angle θ12 increases as becoming closer to the first corner 15.

In addition to chips generated by the first cutting edge 23, chips generated by the corner cutting edge 27 and the second cutting edge 25 may flow to a region in the first inner inclined surface 45b which is located close to the first corner 15. If the first inner inclined surface 45b includes the part thereof where the inclination angle θ12 increases as becoming closer to the first corner 15, it may be easy to ensure a chip flow space in the region in the inner inclined surface 45b located close to the first corner 15. Consequently, chip clogging may be less likely to occur.

The second outer inclined surface 47a and the second inner inclined surface 47b may respectively include parts thereof where the inclination angles θ21 and 022 decrease as going away from the first corner 15. Alternatively, the second outer inclined surface 47a and the second inner inclined surface 47b may respectively include parts thereof where the inclination angles θ21 and 022 increase as going away from the first corner 15. Still alternatively, the inclination angle θ21 of the second outer inclined surface 47a and the inclination angle θ22 of the second inner inclined surface 47b may be kept constant.

For example, if the second cutting edge 25 is used as a bottom cutting edge, chips generated by the second cutting edge 25 may tend to have a small thickness. If the inclination angle θ21 of the second outer inclined surface 47a and the inclination angle θ22 of the second inner inclined surface 47b are kept constant, a flow direction of chips generated by the second cutting edge 25 may tend to become stable. Thus, with the insert 1 in a non-limiting embodiment illustrated in FIGS. 11 to 13, the second cutting edge 25 may be usable as an excellent bottom cutting edge.

The phrase that “the inclination angle θ21 of the second outer inclined surface 47a and the inclination angle θ22 of the second inner inclined surface 47b are kept constant” may not denote that these inclination angles θ21 and 022 are kept strictly constant. There is no problem if the inclination angle θ21 of the second outer inclined surface 47a and the inclination angle θ22 of the second inner inclined surface 47b are evaluated as being constant even if the inclination angles θ21 and 022 have variations of approximately 2-3°.

The corner outer inclined surface 49a may include a part thereof where the inclination angle θ31 decreases as becoming closer to the first side 11 as in a non-limiting embodiment illustrated in FIGS. 14 to 16. As stated earlier, the large cutting load may tend to be applied in the vicinity of the boundary between the first corner 15 and the first side 11. If the corner outer inclined surface 49a includes the part thereof where the inclination angle θ31 decreases as becoming closer to the first side 11, it may be easy to ensure a thickness of the corner cutting edge 27 in a region in the corner outer inclined surface 49a which corresponds to a portion susceptible to a large cutting load. Therefore, the insert 1 having the above configuration may have enhanced durability.

For a similar reason, the corner inner inclined surface 49b may include a part thereof where the inclination angle θ32 decreases as becoming closer to the first side 11.

The insert 1 may include a through hole 51 that opens into regions located on opposite sides in the lateral surface 7 as in the non-limiting embodiment illustrated in FIG. 1. A central axis of the through hole 51 may be inclined relative to the central axis O1 of the insert 1 or may be orthogonal to the central axis O1.

The through hole 51 may be usable for inserting, for example, a screw when fixing the insert 1 to the holder. Instead of the screw, for example, a clamping member may be used to fix the insert 1 to the holder. Although the through hole 51 opens into the regions located on the opposite sides in the lateral surface 7, the through hole 51 is not limited to the above configuration. For example, the through hole 51 may be formed from the center of the first surface 3 toward the center of second surface 5.

The first surface 3 may include a surface region other than the land surface 29 and the inclined surface 31 described above. For example, the first surface 3 may include a surface region 3a located so as to surround an opening of the through hole 51. The second surface 5 may include a flat surface region corresponding to the flat surface region in the first surface 3. If the second surface 5 includes the above surface region, the insert 1 may be stably fixable to the holder.

The above surface region in the second surface 5 may be orthogonal to the central axis O1. If the surface region is orthogonal to the central axis O1, the insert 1 may be more stably fixable to the holder.

The flat surface region is not limited to a strict flat surface. The surface region may be approximately flat and may have a slight curve or slight irregularities to the extent that the curve or irregularities cannot be observed in a general view of the insert 1. Specifically, for example, the flat surface 39 may have slight irregularities of approximately several tens of μm.

For example, cemented carbide and cermet may be usable as a material of the insert 1. Examples of composition of the cemented carbide may include WC—Co, WC—TiC—Co and WC—TiC—TaC—Co. WC, TiC and TaC may be hard particles, and Co may be a binding phase.

The cermet may be a sintered composite material obtainable by compositing metal into a ceramic component. Examples of the cermet may include titanium compounds composed mainly of titanium carbide (TiC) or titanium nitride (TiN). The material of the insert 1 is not limited to the above composition.

A surface of the insert 1 may be coated with a coating film by using chemical vapor deposition (CVD) method or physical vapor deposition (PVD) method. Examples of composition of the coating film may include titanium carbide (TiC), titanium nitride (TiN), titanium carbonitride (TiCN) and alumina (Al₂O₃).

<Cutting Tools>

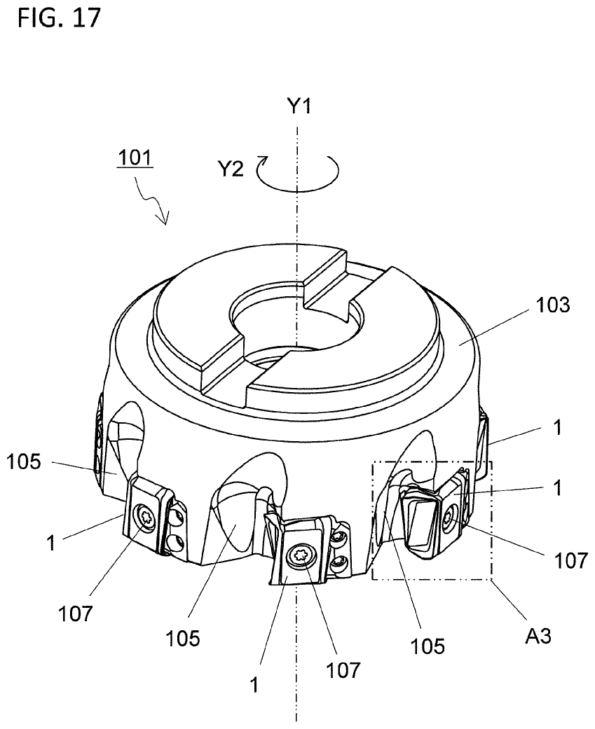

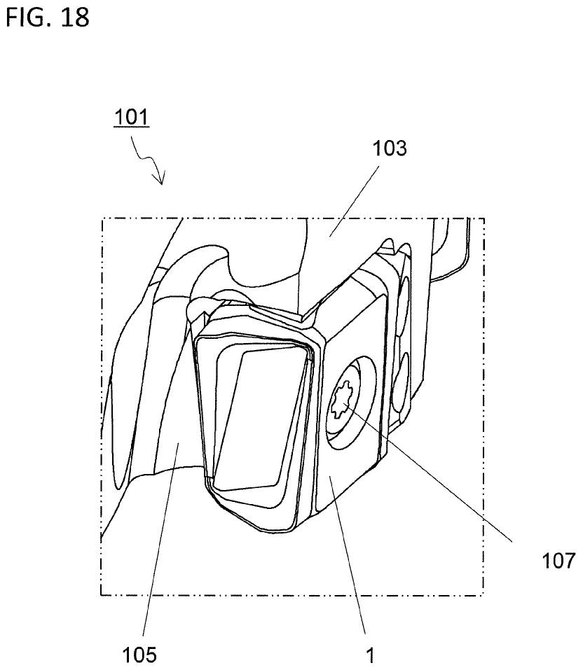

A cutting tool 101 in non-limiting aspects of the present disclosure may be described below with reference to FIGS. 17 and 18. FIGS. 17 and 18 may illustrate a state where the insert 1 illustrated in FIG. 1 is attached to a pocket 105 of a holder 103 by a screw 107. A rotation axis Y1 of the cutting tool 101 may be indicated by a two-dot chain line in FIG. 17 or the like.

The cutting tool 101 in the non-limiting aspects of the present disclosure may be usable for a milling process. The cutting tool 101 may include the holder 103 and the insert 1 as illustrated in FIG. 17. The holder 103 may have a columnar shape extended from a first end to a second end along a rotation axis Y1. The holder 103 may include a pocket 105 located at a side of the first end. The insert 1 may be located in the pocket 105.

The holder 103 may include only one pocket 105, or alternatively, a plurality of pockets 105 as in a non-limiting embodiment illustrated in FIG. 17. If the holder 103 includes the pockets 105, the cutting tool 101 may include the inserts 1, and the inserts 1 may be respectively located in the pockets 105.

The pocket 105 may open into an outer peripheral surface of the holder 103 and an end surface at a side of the first end. In cases where the holder 103 includes the pockets 105, these pockets 105 may be located at equal intervals or unequal intervals around the rotation axis Y1. As apparent from, for example, the fact that the holder 103 includes the pockets 105, the holder 103 may not be a strict columnar shape.

The insert 1 may be attached to the pocket 105 so that at least a part of the cutting edge is protruded from the holder 103. Specifically, the insert 1 of the non-limiting aspects of the present disclosure may be attached to the holder 103 so that the first cutting edge is located more outward than the outer peripheral surface in the holder 103 and the second cutting edge is protruded from the holder 103 toward a workpiece.

At least the second surface, the flat surface region on the second surface and the lateral surface in the insert 1 may be in contact with the holder 103 in the cutting tool 101 in the non-limiting aspects of the present disclosure.

The insert 1 may be attached to the pocket 105 by a screw 107. Specifically, the insert 1 may be attached to the holder 103 by inserting the screw 107 into a screw hole of the insert 1, and by inserting a front end of the screw 107 into a screw hole formed in the pocket 105 so as to fix the screw 107 to the screw hole. For example, steel or cast iron may be usable for the holder 103. Of these materials, the use of steel may particularly contribute to enhancing toughness of the holder 103.

<Method for Manufacturing Machined Product>

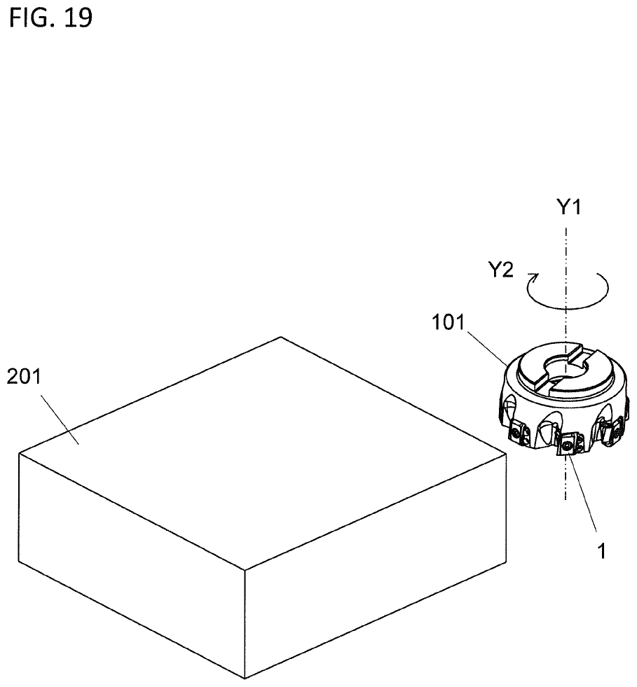

A method for manufacturing a machined product in non-limiting aspects of the present disclosure may be described below with reference to FIGS. 19 to 21. FIGS. 19 to 21 may illustrate a method for manufacturing a machined product in a cutting process using the above cutting tool. The rotation axis Y1 of the cutting tool 101 may be indicated by a two-dot chain line in FIGS. 19 to 21. The machined product 203 may be manufacturable by carrying out the cutting process of the workpiece 201. The manufacturing method in the non-limiting aspects of the present disclosure may include the following steps:

(1) rotating the cutting tool 101 represented by the foregoing aspects;

(2) bringing the cutting tool 101 being rotated into contact with the workpiece 201; and

(3) moving the cutting tool 101 away from the workpiece 201.

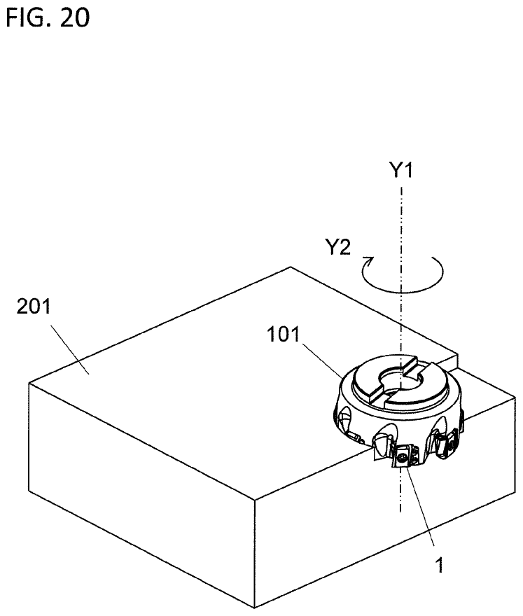

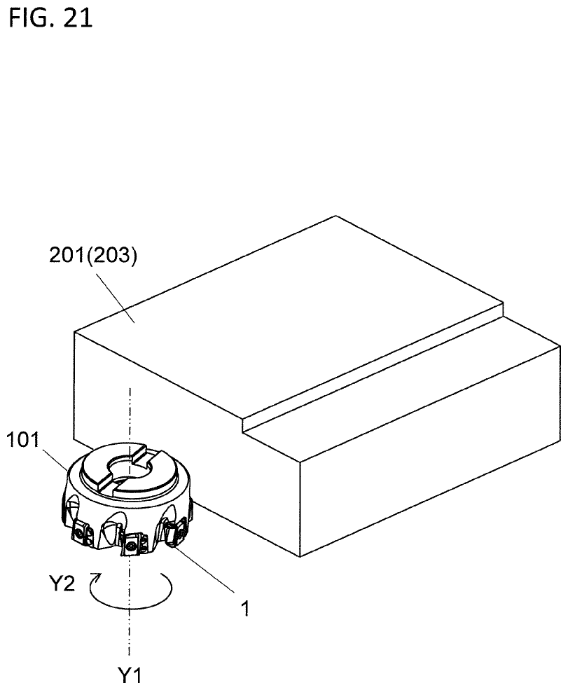

More specifically, firstly, the cutting tool 101 may be relatively brought near the workpiece 201 while rotating the cutting tool 101 in Y2 direction around the rotation axis Y1 as illustrated in FIG. 19. The workpiece 201 may be then cut out by bringing the cutting edge in the cutting tool 101 into contact with the workpiece 201 as illustrated in FIG. 20. Thereafter, the cutting tool 101 may be relatively moved away from the workpiece 201 as illustrated in FIG. 21.

In the non-limiting aspects of the present disclosure, the workpiece 201 may be fixed and the cutting tool 101 may be brought near the workpiece 201. The workpiece 201 may be fixed and the cutting tool 101 may be rotated around the rotation axis Y1 in FIGS. 19 to 21. The workpiece 201 may be fixed and the cutting tool 101 may be moved away in FIG. 21. During the cutting process with the manufacturing method in the non-limiting aspects of the present disclosure, the workpiece 201 may be fixed and the cutting tool 101 may be moved in each of the steps. However, it is not intended to limit to these non-limiting aspects.

For example, the workpiece 201 may be brought near the cutting tool 101 in the step (1). Similarly, the workpiece 201 may be moved away from the cutting tool 101 in the step (3). If desired to continue the cutting process, the step of bringing the cutting edge in the insert into contact with different portions of the workpiece 201 may be repeated while keeping the cutting tool 101 rotated.

Representative examples of material of the workpiece 201 may include carbon steel, alloy steel, stainless steel, cast iron and nonferrous metals.

### DESCRIPTION OF THE REFERENCE NUMERAL

1 cutting insert (insert)
3 first surface
5 second surface
7 third surface (lateral surface)
9 cutting edge
11 first side
13 second side
15 first corner
17 first lateral surface
19 second lateral surface
21 corner lateral surface
23 first cutting edge
25 second cutting edge
27 corner cutting edge
29 land surface
31 inclined surface
33 first land surface
35 second land surface
37 corner land surface
39 first curvilinear part
41 second curvilinear part
43 connection part
45 first inclined surface
45a first outer inclined surface
45b first inner inclined surface
47 second inclined surface
47a second outer inclined surface
47b second inner inclined surface
49 corner inclined surface
49a corner outer inclined surface
49b corner inner inclined surface
51 through hole
101 cutting tool
103 holder
105 pocket
107 screw
201 workpiece
203 machined product
O1 central axis

1. A cutting insert, comprising:
a first surface comprising a first side, a second side and a first corner located between the first side and the second side;
a second surface located on a side opposite to the first surface;
a third surface located between the first surface and the second surface; and
a cutting edge located on an intersection of the first surface and the third surface,
wherein
an imaginary straight line passing through a center of the first surface and a center of the second surface is a central axis, and an imaginary flat surface which is located between the first surface and the second surface and which is orthogonal to the central axis is a reference plane,
the first surface further comprises
a land surface located along the first side, the second side and the first corner, and
an inclined surface which is located along the land surface and which becomes closer to the reference plane as going away from the land surface,
the land surface comprises
a first land surface located along the first side,
a second land surface located along the second side, and
a corner land surface located along the first corner,
an inclination angle of the first land surface relative to the reference plane is a first land angle, an inclination angle of the second land surface relative to the reference plane is a second land angle, and an inclination angle of the corner land surface relative to the reference plane is a corner land angle, and
the first land surface comprises a part thereof where the first land angle increases as going away from the first corner, and the corner land surface comprises a part thereof where the corner land angle increases as going away from the first side.

2. The cutting insert according to claim 1, wherein a maximum value of the second land angle is larger than a maximum value of the first land angle.

3. The cutting insert according to claim 1, wherein the second land surface comprises a part thereof where the second land angle increases as going away from the first corner.

4. The cutting insert according to claim 1, wherein the first surface has a longitudinal shape, the first side is a long side and the second side is a short side in a plan view of the first surface.

5. The cutting insert according to claim 1, wherein the second land surface comprises a part thereof whose width decreases as going away from the corner land surface in a plan view of the first surface.

6. The cutting insert according to claim 1, wherein the first corner comprises, in a plan view of the first surface,
a first curvilinear part which is located at a side of the first side and has a convex curvilinear shape,
a second curvilinear part which is located at a side of the second side and has a convex curvilinear shape, and
a connection part which connects to the first curvilinear part and the second curvilinear part and has a straight line shape.

7. The cutting insert according to claim 6, wherein, in the plan view of the first surface,
each of the first curvilinear part and the second curvilinear part has a circular arch shape, and
a radius of curvature of the first curvilinear part is larger than a radius of curvature of the second curvilinear part.

8. The cutting insert according to claim 6, wherein a first imaginary angle formed by an imaginary line extended from the first side and an imaginary line extended from the connection part is smaller than a second imaginary angle formed by an imaginary line extended from the second side and an imaginary line extended from the connection part in the plan view of the first surface.

9. The cutting insert according to claim 6, wherein the connection part is located more away from the reference plane as going from a side of the first curvilinear part toward a side of the second curvilinear part.

10. The cutting insert according to claim 9, wherein the first curvilinear part has a curvilinear shape recessed in a direction becoming closer to the reference plane in a plan view of the third surface.

11. The cutting insert according to claim 9, wherein the second curvilinear part has a curvilinear shape protruded in a direction away from the reference plane in a plan view of the third surface.

12. A cutting tool, comprising:
a holder which has a columnar shape extended from a first end to a second end along a rotation axis and comprises a pocket located at a side of the first end; and
the cutting insert according to claim 1, the cutting insert being located in the pocket.

13. A method for manufacturing a machined product, comprising:
rotating the cutting tool according to claim 12;
bringing the cutting tool being rotated into contact with a workpiece; and
moving the cutting tool away from the workpiece.
